(19) United States
(12) Patent Application Publication
(10) Pub. No.: US 2011/0217440 A1
(43) Pub. Date: Sep. 8, 2011

(54) METHOD FOR PRODUCING AND EXTEMPORARILY SELLING FOOD SUBSTANCES AND EXPOSING AND SELLING EQUIPMENT ACCORDING SAID METHOD

(75) Inventor: Renzo Grotti, Castelmaggiore (IT)

(73) Assignee: IDEA3A S.R.L., Castelmaggiore (BO) (IT)

(21) Appl. No.: 13/124,927

(22) PCT Filed: Oct. 27, 2008
(86) PCT No.: PCT/IT2008/000667

§ 371 Date: May 11, 2011

(51) Int. Cl. A23G 9/04; A23G 9/12; A23G 9/22; A23G 9/28

(52) U.S. Cl. 426/519; 99/485; 99/348

(57) ABSTRACT

The invention refers to a method and an equipment for producing, exposing and extemporaneously retailing foodstuffs subjected to thermal treatment and mixing or stirring, particularly of Italian ice cream or similar, having several flavors, wherein:—several flavors of such foodstuffs are produced, particularly of ice cream or similar in at least as many treatment units, each one having a stirring or batch cylinder and thermal treatment means; the obtained product is preserved in the corresponding stirring or batch cylinders; and—product measures are taken out whenever requested by consumers directly from said stirring or batch cylinders.

### FIELD OF THE INVENTION

The invention refers to a novel methodology for producing and extemporaneously retailing foodstuffs requiring, for their production, a thermal treatment and a contemporaneous mixing or stirring action.

A typical and preferred example of such foodstuffs is the so-called Italian ice cream or similar products, such as for example crushed ice drinks, but substances obtainable from heating too, as various edible cream kinds.

The invention concerns also an equipment for producing and extemporaneously retailing the afore said foodstuffs.

Throughout the present specification reference to the Italian ice cream will be made, but it is to be understood that such a definition or better the term “Italian ice cream or similar”, will designate also other foodstuffs to which the invention could be applied and, as mentioned, that are obtained from thermal treatment and contemporaneous mixing or stirring operations.

### DESCRIPTION OF THE KNOWN ART

Ice cream is actually produced and sold with two different technologies and procedures, and comprises the so-called soft ice cream and the so-called Italian ice cream.

The soft ice cream is produced in appropriate machines providing its continuous production and driven dispensing, often automatically, of a mixture of ice cream and air.

The Italian ice cream, having organoleptic characteristics completely different from the former one, is homemade, usually in laboratories adjoining an extemporaneously retail shop, wherein a refrigerated display counter exhibits to consumers a plurality of tubs, each comprising some amount of ice cream with a determined flavor.

The production happens, as afore said, in a laboratory adjoined to the retail shop, where one or more production machines are located, particularly one or more batch freezers and eventually one or more pasteurizers or cooking machines.

The pasteurized mixture to be batch frozen is introduced into a batch cylinder provided with cooling means for its walls, and eventually the bottom, and with stirring blades treating the cooled liquid mixture until the desired pasty consistency is reached. At this point the ice cream is drained from the batch freezer and maintained in a cool environment, more often transferred in one or more exposing tubs intended to be placed over the selling counter or preserved in a cooled environment awaiting to be exposed for selling. The batch freezer is then washed to be ready for treating a following mixture, generally having a different flavour from the former one.

This procedure involves several drawbacks already present today. First of all the ice cream handling from the batch freezer to the tubs and, with these, into the cooler or the refrigerated display counter, causes a hard engagement for the operator carrying it out, and further presents hygiene problems and deteriorations of the organoleptic characteristics, because the ice cream is exposed to the environment for a more or less long period, with a consequent alteration of its characteristics, obviously starting from the surface.

Secondly, the necessary equipments are numerous and bulky, whereby in any case the complex laboratory-retail shop must occupy a predetermined minimum surface.

### OBJECT OF THE INVENTION

Object of the present invention is now to remedy these and other drawbacks and disadvantages of the known procedure and art, realizing among other things a number of means allowing to produce and directly sell the Italian ice cream or the afore said foodstuffs, without the substance being carried and handled before its withdrawal for selling, and further without it would be exposed in tubs for selling.

Other objects of the invention are to provide a procedure and an equipment for producing and selling the Italian ice cream or similar substances allowing to reduce the totally occupied space for such a functions and allowing the consumer not only to verify the appearance of the substance for sale, but also to watch the producing operations of the substance itself and eventually to visually control the various production steps.

For realizing these and other objects, the present invention concerns a new method for producing and selling the Italian ice cream or similar substances, as generally defined in claim 1, as well as a new equipment, especially designed for actuating the mentioned method, as more generically defined in claim 4.

### DESCRIPTION OF THE FIGURES

These and other peculiarities and characteristics of the invention will be evident from the subsequent description of a preferred embodiment of an equipment for producing and selling Italian ice cream, herein illustrated in the drawings in attachment, wherein:

FIG. 1 is a perspective view of an equipment for producing and selling Italian ice cream according to the invention, in the shape of a display counter.

FIG. 2 is a perspective view of a module with four batch freezers belonging to the display counter of FIG. 1.

FIG. 3 is an elevation view of the module of FIG. 2.

FIGS. 4 and 5 are perspective views illustrating the stirring drive means of one of the batch freezers, in a disassembled and assembled condition respectively.

FIG. 6 is a scheme of a particular and preferred circuit for controlled cooling or heating of a batch cylinder.

FIG. 7 is an elevation view of a batch cylinder realized for carrying out the controlled cooling or healing procedures according to the FIG. 6 scheme.

### DESCRIPTION OF THE PREFERRED EMBODIMENTS

According to what hereinbefore exposed and claimed, the invention concerns a method for producing and extemporaneously retailing Italian ice cream and other foodstuffs, with several flavors, allowing to eliminate the drawbacks and the disadvantages afore mentioned, essentially producing single ice cream flavors, or similar, in at least as much treatment units or batch freezing units, preserving then the ice cream or similar in the same producing cylinders and taking it out directly from the same cylinders as a consequence of the consumer requests.

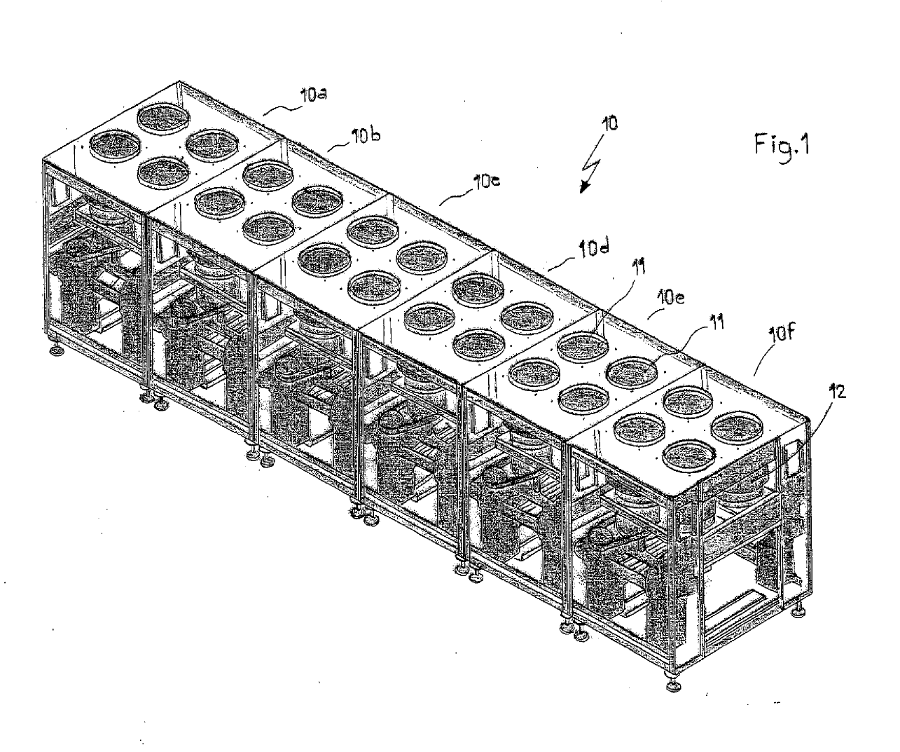

To realize such a method, the invention provides an equipment for producing, exposing and extemporaneously retailing the ice cream, or similar, of the type shown in the attached figures and more generally in FIG. 1.

In such a figure an equipment is illustrated having a shape of a selling counter 10 composed of a plurality of similar modules 10a, 10b, 10e, 10d, 10e, 10f, and in reciprocal abutment so that to present to the buyer a predetermined amount of flavours, for example visible to the buyer through transparent lids 11 opposed to each vertical cylinder 12 for producing and preserving the ice cream or similar.

In this way the foregoing objects of the present invention are realized, particularly obtaining and preserving better organoleptic product characteristics, reducing the work engagement of the operator/operators and further reducing the spaces required by the necessary equipments for a homemade shop for producing and selling ice cream or similar, practically to the spaces occupied by the counter 10.

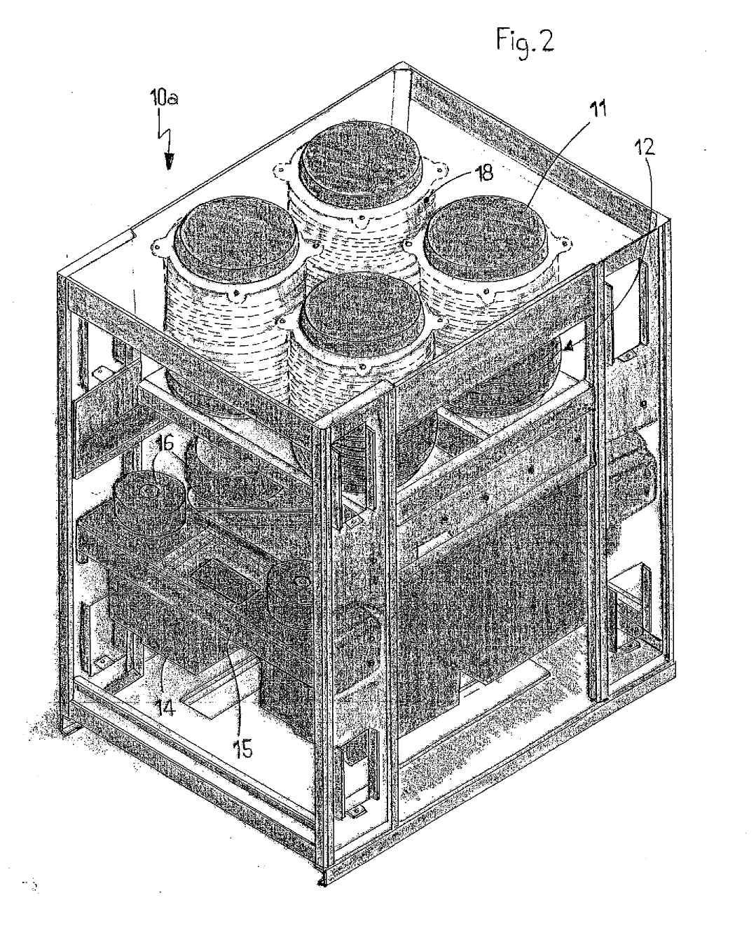

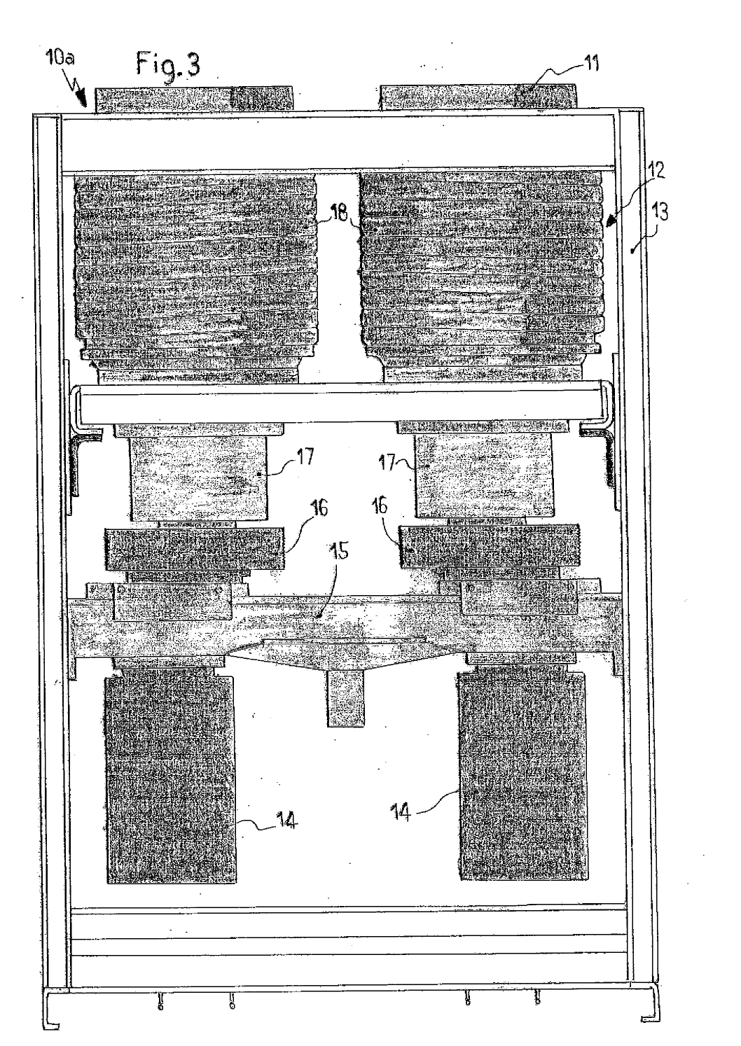

Referring to FIGS. 2 and 3, every module, for example 10a, presents a supporting frame 13 adapted to sustain and exhibit for example four vertical producing cylinders 12, particularly for batch freezing and preserving the ice cream, each one having a batch freezing stirrer driven by a motor 14 supported by a crossbeam 15.

Every motor 14 drives, by pulleys 16, a corresponding drive shaft (not visible, in FIGS. 2 and 3), supported by the bearings housed in the casing 17. The drive shaft is rotating in a cylindrical receptacle 12 having a preferably transparent lid 11 and driving the rotation of the batch stirring or mixing known blades.

The outer wall of each cylinder 12 is wound by a coil 18 directly or indirectly generating and/or maintaining the requested temperature for producing and/or conserving ice cream. The coil 18 is in turn connected to an appropriately dimensioned freezing unit provided with air or water compressor and condenser. The unit may be assigned to serve a specific module 10a, or preferably the whole counter 10. The temperatures in the cylinder 12 may be adjusted particularly to have different values when the cylinder is intended for producing ice cream, or when the same operates a preservation of the produced ice cream only, otherwise still when different temperatures are requested, eventually higher than the environment one.

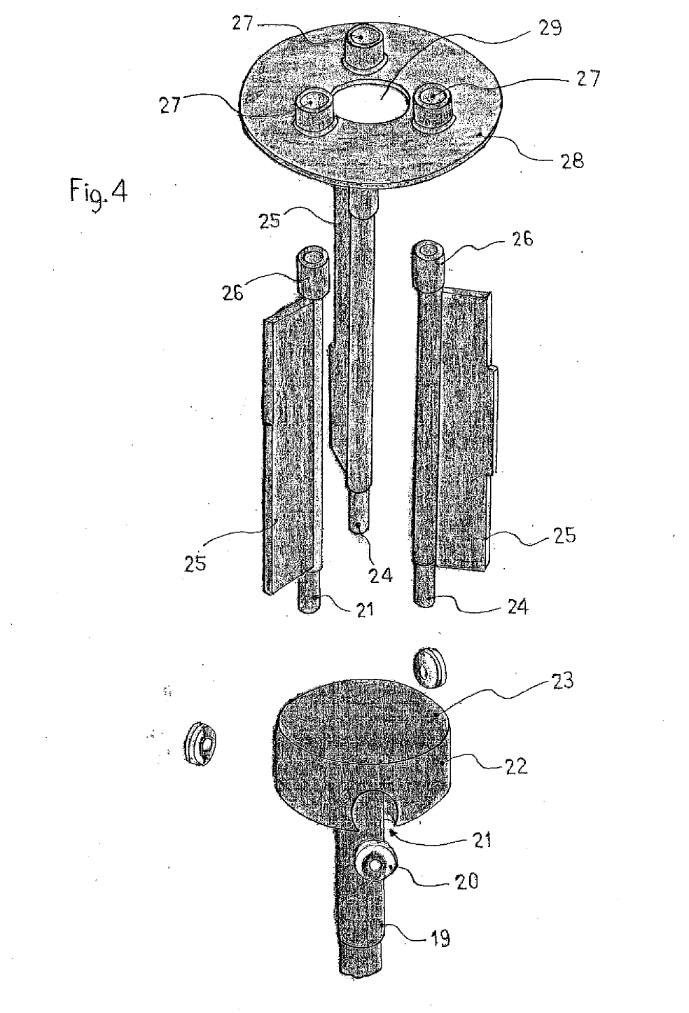

In FIGS. 4 and 5 is illustrated an embodiment of batch freezing means, essentially composed of a shaft 19 rotated by a corresponding motor 14 and rotating in abutment over the bearings 20 inserted in seats 21 of a flange 22 integral with the shaft 19. Further on its upper face the flange 22 presents seats 23 for housing cylindrical endings 24 of the batch freezing blades 25.

In the upper portion the blades 25 exhibit a further cylindrical ending 26 adapted for housing into seats 27 of a covering element 28, that is preferably transparent. The covering element 28 exhibits a further central opening 29 to introduce the components for the mixture to be prepared. The whole is then covered by a preferably transparent lid 11 with safety sensors (not illustrated), adapted to interrupt stirring when the lid 11 is raised.

To serve the produced ice cream, the blades 25 may be eventually drawn out, with the covering element 28 too, for a better access to the containing cylinder.

It has to be noticed that in case of ice creams requesting a preventive pasteurization or cooking operation, such an operation may be conducted separately or in the same batch cylinders 12, conveniently by adjusting the operating procedures, particularly the temperature, for example in the way herein after explained. The same operations can be carried out in case of heating and stirring edible creams.

It has been noticed that a batch cylinder capacity comprised from 4 to 10 liters allows to better carry out the objects of the invention. However, it has to specified that the invention is not to be considered limited to these values, because it is possible to have cylinders with a lower or greater capacity than the suggested ones.

Further, it is possible to throttle the refrigeration of every cylinder or of some cylinders, because of cost savings, when the product is in the preserving step in a reduced amount.

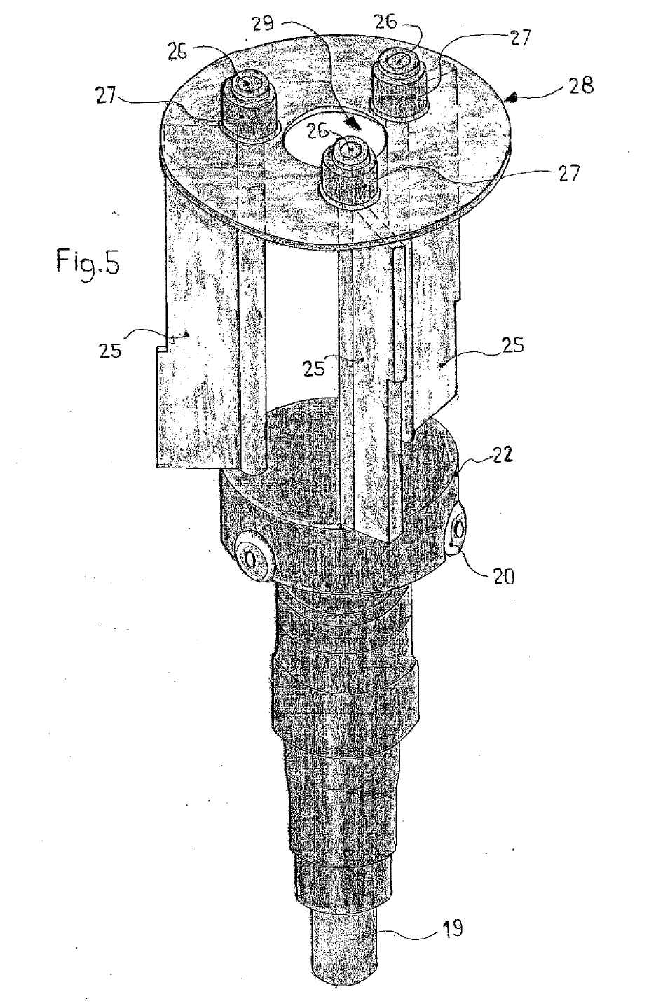

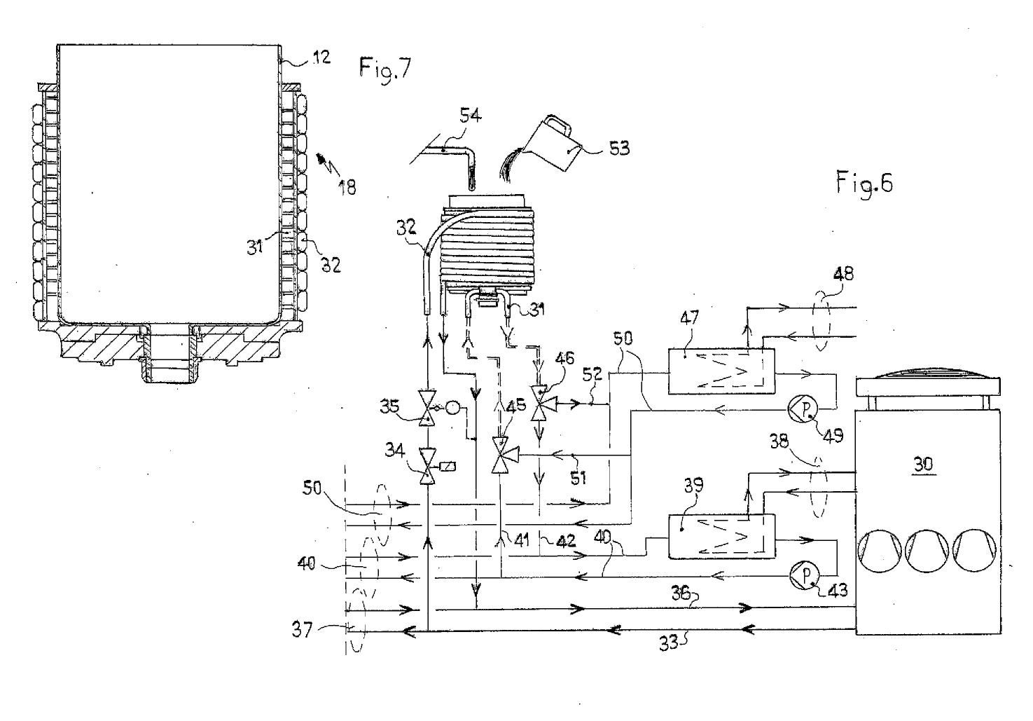

FIGS. 6 and 7 respectively show a particularly preferred thermic controlling circuit for a batch cylinder 12 and the treating coil structure at the outer wall of such a cylinder 12.

Referring first to FIG. 6, a refrigerant unit 30, with a water or air condensation, of an itself known type, preferably operates for every batch cylinder 12 of the counter 10. Every batch cylinder 12 has its own outer side wall wound by a coil 18 that, in this particular case, as illustrated in FIG. 7, is actually formed by two overlying coils, of which the inner one 31 operates for the glycol circulation, whereas the outer one 32 circulate the cooling gas coining directly from the unit 30.

Referring again to FIG. 6, the refrigerant unit 30 feeds with a cooled gas a cooling circuit of the coil 32, provided with an intake trunk 33, with a shut-off valve 34 and an expansion valve 34′, as well as a returning trunk 35. The coil 32 is able then to cool, crossing the coil 31, the inner of the cylinder 12 to the requested temperature to carry out the batch freezing.

Once the batch freezing is finished, the ice cream obtained must be conserved at a temperature lower than the environment temperature, but strongly higher than the batch freezing temperature. To obtain this, the cooled gas outgoing from the refrigerant unit 30 is sent, through a separated circuit 36, to an heat exchanger 37 where glycol is cooled and then sent to the coil 31 through a circuit 38, provided with a shut-off valve 39 and fed by a pump 40.

The described circuit operation is as follows. During the batch freezing step in the concerned cylinder 12, the valve 39 is closed and the glycol pump 40 is stopped, whereas the valve 34 is opened to allow the cooling gas to circulate in the coil 32 and obtain the freezing desired temperature for the mixture in the cylinder 12. At the end, the valve 34 is closed, whereas the valve 39 is opened and the pump 40 is operated, to circulate the glycol in the coil 31 and thereby to maintain the ice cream at the preserving desired temperature.

In case wherein pasteurization or cooking in the cylinder 12 are desired, or further a thermic cream treatment at a higher temperature than the environment one, a third circuit (not illustrated), provided with an opening or closing valve too and with temperature regulating means, may connect the hot gas exiting from the refrigerant unit with the coil 32 or with the heat exchanger 37 and then with the coil 31, thereby realizing an high temperature appropriate thermic treatment.

As an alternative to low temperature cooling during the batch freezing, it is possible, by removing the circuit 33-35, to enter into the cylinder 12 an appropriate and controlled amount of liquid nitrogen, both manually (as exemplified in 41), and preferably by a duct 42, directly into the stirring mixture.

1-22. (canceled)

23. A method for producing and extemporaneously retailing foodstuffs subjected to thermal treatment and mixing or stirring, and having several flavors visibly exposed to customer, comprising:
a) producing several single flavors of such foodstuffs, in at least as many treatment units, each one having a stirring or batch vertical cylinder fitted with vertical stirring means and thermal treatment means;
b) preserving the obtained product in the corresponding vertical stirring or batch cylinders;
c) taking out the amount of single flavors required by a customer directly from the inlet at the upper level of said vertical stirring or batch cylinders.

24. A method according to claim 23, further comprising preventive pasteurizing or cooking the foodstuffs, in the same stirring or batch cylinders.

25. A method according to claim 23, further comprising modifying the cooling and/or stirring conditions to throttle the production.

26. An equipment for producing, exposing and retailing foodstuffs subjected to thermal treatment and mixing or stirring, and having several single flavors, comprising a plurality of stirring and batch vertical cylinders, each one provided with thermal treatment means and vertical stirring means, said cylinders being adapted to preserve product therein obtained and being available to an operator for taking out single product measures, each stirring or batch vertical cylinder having an inlet substantially at the upper level of the exposing equipment for introducing into the cylinder and taking out the product.

27. An equipment according to claim 26, wherein each stirring or batch cylinder involves stirring means activable and deactivable by control, as well as cooling means controllable to provide at least two temperatures, respectively for product thermal treatment and for preserving the product.

28. An equipment according to claim 26, wherein that said stirring means are composed of batching blades or similar releasably mounted into the corresponding cylinder.

29. An equipment according to claim 26, wherein at least a batch cylinder portion involves means to carry out in the same cylinders a preventive pasteurization cooking.

30. An equipment according to claim 29, wherein that every stirring or batch cylinder has a removable lid.

31. An equipment according to claim 26, wherein said equipment is composed of two or more modules, each presenting one or more stirring or batch cylinders having in common at least part of the thermal treatment means and/or at least part of the stirrer driving means.

32. An equipment according to claim 26, wherein each stirring or batch cylinder has a capacity of from 4 to 10 liters.

33. An equipment according to claim 23, wherein each stirring and batch cylinder has separated thermal treatment means, respectively intended for providing temperatures more distant or closer to room temperature.

34. An equipment according to claim 33, wherein the thermal treatment means intended for providing more distant temperatures relative to the room temperature are composed of a coil which is connectable under control to a refrigerant unit.

35. An equipment according to claim 34, wherein said refrigerant unit is adapted to provide an appropriate temperature to the coil or coils for batch freezing the ice dream or similar.

36. An equipment according to claim 34, wherein said refrigerant unit is adapted to provide an appropriate temperature to the coil or coils for pasteurizing or cooking the mixture in the stirring or batch cylinder.

37. An equipment according to claim 34, wherein said refrigerant unit is adapted to provide an appropriate temperature to the coil or coils for thermal treatment of edible creams.

38. An equipment according to claim 33 wherein said thermal treatment means intended for providing temperatures closer to the room temperature are in the form of at least one coil wherein glycol is circulated under control, the latter being cooled or heated in at least one heat exchanger.

39. An equipment according to claim 38, wherein said glycol heat exchanger is connected to the refrigerant unit.

40. An equipment according to claim 38, wherein said glycol circuit is adapted to provide an appropriate temperature to the coil or coils for preserving the foodstuff.

41. An equipment according to claim 38, wherein said glycol circuit is adapted to provide an appropriate temperature to the coil or coils for pasteurizing or cooking the mixture in the stirring or batch cylinder.

42. An equipment according to claim 38, wherein said glycol circuit is adapted to provide an appropriate temperature to the coil or coils for thermal treatment of edible creams.

43. An equipment according to claim 33, wherein the thermal treatment means intended for providing more distant temperature from the room temperature are composed of means for controlled inletting liquid nitrogen, or other liquid inert gas, directly into the mixture under treatment.
